(19) United States
(12) Patent Application Publication
(10) Pub. No.: US 2007/0257866 A1
(43) Pub. Date: Nov. 8, 2007

(54) Method and apparatus for defect correction in a display

(75) Inventor: Ronald S. Cok, Rochester, NY (US)

Correspondence Address: Paul A. Leipold,;Patent Legal Staff, Eastman Kodak Company, 343 State Street, Rochester, NY, 14650-2201, US

(73) Assignee: Eastman Kodak Company

(21) Appl. No.: 11/430,065

(22) Filed: May 8, 2006

(51) Int. Cl. G09G 3/30

(52) U.S. Cl. 345/76

(57) ABSTRACT

A method for displaying an image on a display device having defective light-emitting elements, comprising the steps of: a) providing a display having a plurality of light-emitting elements, comprising at least one light-emitting element that is defective and additional light-emitting elements; b) providing a plurality of distinct image-content dependent defect-masking compensation computations, at least one of which includes the step of selectively modifying the light output of an additional light-emitting element; c) analyzing an input image signal to determine a preferred defect-masking compensation computation for driving additional light-emitting elements in the vicinity of the defective light-emitting element; d) compensating the input image signal with the determined preferred defect-masking compensation computation; and e) driving the light-emitting elements of the display to display a defect-masked compensated image.

### FIELD OF THE INVENTION

The present invention relates to a method for displaying an image on display devices having defective light-emitting elements, and more particularly to correcting for defective light-emitting elements in a display.

### BACKGROUND OF THE INVENTION

Flat-panel display devices, for example plasma, liquid crystal and Organic Light Emitting Diode (OLED) displays have been known for some years and are widely used in electronic devices to display information and images. Such devices employ both active-matrix and passive-matrix control schemes and can employ a plurality of colored light-emitting elements to form a full-color, pixellated display. Each pixel comprises a plurality of colored sub-pixel light-emitting elements, for example red, green, and blue. It is also known to provide color displays with four colored sub-pixels in each pixel of a full-color display to reduce power usage, for example as taught in U.S. Pat. No. 6,919,681 by Cok et al. The light-emitting elements are typically arranged in two-dimensional arrays with a row and a column address for each light-emitting element and having a data value associated with each light-emitting element to emit light at a brightness corresponding to the associated data value. In some displays, the colored sub-pixels are formed in rows or columns of a common color; in other displays neighboring rows or columns are offset from each other.

In general, displays suffer from a variety of defects that limit their quality. In particular, displays may suffer from defective light-emitting elements that do not respond properly to control signals, for example, the defective light-emitting elements may be permanently turned on, permanently turned off, be brighter, and/or be dimmer than intended for a given control signal. These non-uniformities can be attributed to the light-emitting or light-controlling materials in the display or, for active-matrix displays, to variability or failures in the thin-film transistors used to drive the light emitting elements. Moreover, applicants have determined through experiments that defective light-emitting elements vary in the accuracy of their response at different brightness levels so that a light-emitting element may have a more accurate response at some light levels than at others. In other words, a pixel may be defective at one light level but less defective or not defective at all at another light level. Furthermore, most displays are color displays having pixels with three or four colored light-emitting elements and defects may be found in one color light-emitting element of a display pixel but not in the other color light-emitting elements of the same pixel. Such defects reduce the quality, reduce the manufacturing yields, and increase the costs of flat-panel displays.

A variety of schemes have been proposed to correct for non-uniformities in displays. Many such schemes are addressed to improving the uniformity of the light-emitting elements, for example, U.S. Pat. No. 6,989,636 describes providing an OLED display having a plurality of light-emitting elements with a common power signal and local control signals; providing a digital input signal for displaying information on each light-emitting element, the signal having a first bit depth; transforming the digital input signal into a transformed digital signal having a second bit depth greater than the first bit depth; and correcting the transformed signal for one or more light-emitting elements of the display by applying a local correction factor to produce a corrected digital signal. However, such uniformity correction schemes do not correct for display devices having defective light-emitting elements that are stuck on or stuck off, or that are not sufficiently responsive to control signals to perform the desired correction.

Some correction methods for masking stuck light-emitting elements in a display are known. Referring to FIG. 10, in a prior-art illustration, a display having pixels 38 with sub-pixels 30, 32, and 34 forming a color gamut (e.g. red, green, blue), a defective sub-pixel 20 may be compensated by driving the nearest sub-pixels of a common color (22, 24, 26, 27). However, such an approach often creates visible spatial artifacts because of the distance between the sub-pixels of a common color.

A more sophisticated version of defective pixel compensation is described in WO/2005/052902 and “Solving the Problem of Pixel Defects in Matrix Displays based on Characteristics of the Human Visual System” by Kimpe et al, in the Proceedings of the 25^{th} International Display Research Conference EuroDisplay 2005, 20-22 Sep. 2005, Edinburgh, Scotland, paper 7.3, p. 82. In this approach, defects are masked by using a pixel-data processing algorithm based on characteristics of the human visual system. However, such designs have limited applicability and still result in defect visibility and further improvements are needed. In particular, the masking provided may be highly dependent on the viewing distance to the display. Hence, while this approach is helpful, further improvements may be desired.

WO2003100756 addresses issues found with displays having at least one redundant sub-pixel. This application describes a method for masking faulty sub-pixels in a display having a plurality of pixels formed of a number of sub-pixels, wherein at least one pixel in said display is faulty and comprises at least one sub-pixel having a defect. The method comprises obtaining a set of sub-pixel values for generating desired perceptive characteristics for said pixel and determining a modified set of sub-pixel values for generating modified perceptive characteristics for said pixel. This modified set of sub-pixel values is based on information regarding the sub-pixel defect so as to be implementable in the display, and has values chosen to reduce an error perceived by a user. The modified values are then implemented in the display. The display is preferably of the kind where each pixel comprises a set of primary sub-pixels each emitting a primary color and at least one additional, redundant sub-pixel for emitting an additional color, such as an RGBW display. Referring to FIG. 11, in a prior-art illustration, a display having pixels 38 with sub-pixels 30, 32, and 34 forming a color gamut (e.g. red, green, blue), with an in-gamut sub-pixel 36, a defective in-gamut sub-pixel 40 may be compensated by driving the color sub-pixels 50, 52, and 54 of the same pixel 58. However, in this design, the spatial extent of the corrected light-emitting elements is not optimized, and is thus more visible than may be necessary. This disclosure further mentions the use of image content for adaptively providing sub-pixel weighting parameter values used in the masking computation employed to minimize the error in the light output from the display. Reference is also made to testing more than one set of light-emitting elements including a defective light-emitting element to select the set providing the least correction error. However, this approach may also be viewing-distance dependent. Moreover, the masking may still be visible and objectionable, or make unnecessary masking changes that do not improve viewer perceptions.

There is a need, therefore, for an improved method of compensating for defective light-emitting elements in a display.

### SUMMARY OF THE INVENTION

In accordance with one embodiment, the invention is directed towards a method for displaying an image on a display device having defective light-emitting elements, comprising the steps of:

a) providing a display having a plurality of light-emitting elements, comprising at least one light-emitting element that is defective and additional light-emitting elements;

b) providing a plurality of distinct image-content dependent defect-masking compensation computations, at least one of which includes the step of selectively modifying the light output of an additional light-emitting element;

c) analyzing an input image signal to determine a preferred defect-masking compensation computation for driving additional light-emitting elements in the vicinity of the defective light-emitting element;

d) compensating the input image signal with the determined preferred defect-masking compensation computation; and

e) driving the light-emitting elements of the display to display a defect-masked compensated image.

### ADVANTAGES

In accordance with various embodiments, the present invention may provide the advantage of improved perceived image in a display, and improve display manufacturing yields.

### BRIEF DESCRIPTION OF THE DRAWINGS

FIG. 1 is an illustration of a defective light-emitting element in a display image of a flat field;

FIG. 2 is an illustration of a defective light-emitting element in a display image of an edge;

FIG. 3 is an illustration of a defective light-emitting element in a display image of a line;

FIG. 4 is another illustration of a defective light-emitting element in a display image of a line;

FIG. 5 is an illustration of a defective sub-pixel light-emitting element in a display image of a flat field;

FIG. 6 is an illustration of a defective sub-pixel light-emitting element in a display image of an edge;

FIG. 7 is an illustration of a pixel comprising four light-emitting sub-pixels emitting different colors of light;

FIG. 8 is a schematic diagram of a display device according to an embodiment of the present invention;

FIG. 9 is a flow chart of a compensation method according to an embodiment of the invention;

FIG. 10 is an illustration of a compensation system for defective light-emitting elements according to the prior-art; and

FIG. 11 is an illustration of a compensation system for defective light-emitting elements in a pixel having an in-gamut fourth sub-pixel according to the prior-art.

### DETAILED DESCRIPTION OF THE INVENTION

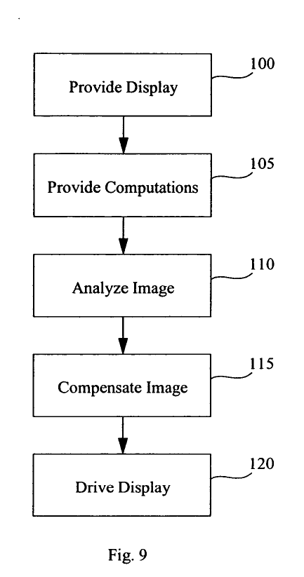

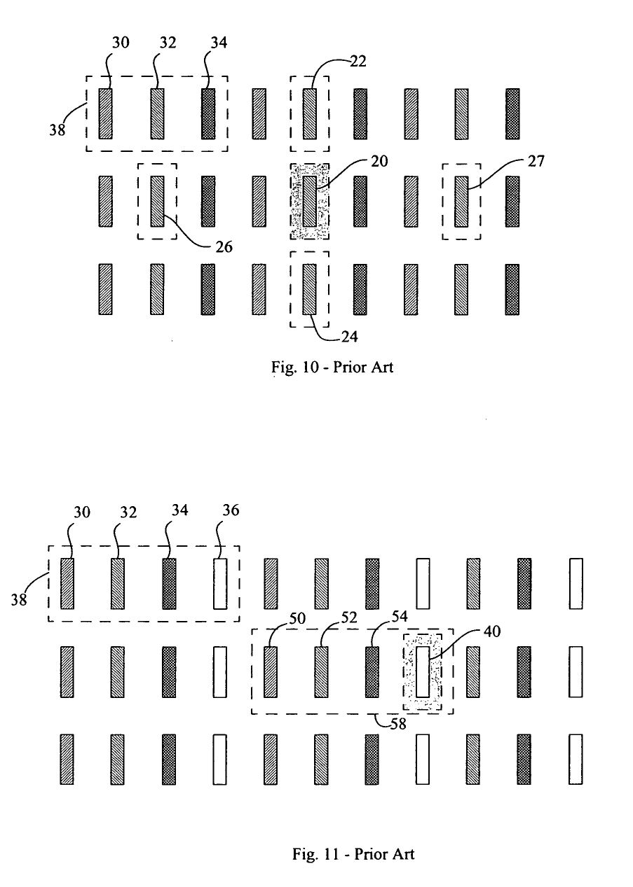

Referring to FIG. 9, a method for compensating a display device having defective light-emitting elements, comprises the steps of a) providing 100 a display having a plurality of light-emitting elements, comprising at least one light-emitting element that is defective and additional light-emitting elements; providing 105 a plurality of distinct image-content dependent defect-masking compensation computations, at least one of which includes the step of selectively modifying the light output of an additional light-emitting element; analyzing 110 an input image signal to determine a preferred defect-masking compensation computation for driving light-emitting elements in the vicinity of the defective light-emitting element; compensating 115 the input image signal with the determined preferred defect-masking compensation computation; and driving 120 the light-emitting elements of the display to display a defect-masked compensated image.

Referring to FIG. 8, a display device may comprise a display 10 having a plurality of light-emitting elements 20, 28, wherein at least one light-emitting element 20 is defective and a controller 12 for computing a plurality of defect-masking compensation algorithms, inputting an image 14, analyzing the input image to determine a preferred compensation algorithm, compensating the image with the determined preferred compensation technique, and displaying the compensated image 16 on the display 10.

According to the present invention, one or more of a variety of defect-masking computations determined to be preferred from a plurality of distinct image-content dependent defect-masking compensation computations may be employed when compensating for defective light-emitting elements, depending on an analysis of attributes of the input image. A variety of computational means may be employed to analyze the image content to determine a preferred computation. For example, convolution, correlation, pattern matching, frequency transforms, morphological processing, edge detection, image feature extraction, image segmentation, shape analysis, statistical analysis, and a priori information concerning image content, structure or attributes may all be used. Similarly, a wide variety of computations may be employed to compensate for defective pixels. The choice of transformation will depend on the nature of the defects, the severity of the defects, the type of imagery displayed, and the nature of the display application. In particular, the resolution and anticipated viewing distance may determine the type of compensation provided. For example, at a relatively high resolution or large viewing distance, the spatial extent of the image signal compensation may be larger while at a relatively low resolution the spatial extent may be reduced. Computational methods for implementing compensation may include convolutions, correlations, contrast manipulation, histogram modification, noise cleaning, color modification, spatial filtering including sharpening and blurring, image restoration, and geometrical image modifications. Such techniques are known in the art and described, for example, in the book “Digital Image Processing” by William K. Pratt, published by John Wiley and Sons, 1991.

The analyzed attributes may be local attributes such as the image structure in the immediate neighborhood of a defective light-emitting element, alone or in combination image attributes over a wider area in the vicinity of the defective element, or in combination with global attributes of the image. In particular, the process of the present invention may undertake an analysis of the local image structure surrounding a defective light-emitting element, and then determine if an additional computation for masking the defect is necessary. If the defective light-emitting element coincidentally outputs light at the desired level, e.g., no action is necessary. More commonly, however, the light emitted from a defective light-emitter is not the desired light output. However, according to the present invention, it may still be preferred not to employ an additional masking operation, based on image attributes over a wider area in the vicinity of the defective element, or global attributes of the image.

In general, masking operations as taught in the prior art involve manipulating the light output from light-emitting elements in the local neighborhood of the defective light-emitter. The success of the masking typically is highly dependent on the viewing distance to the display and, in any case, may create structures in the displayed image that can be unnatural. While use of image content for adaptively providing sub-pixel weighting parameter values used in a particular masking computation has been suggested, such solution does not address those situations wherein significantly different computations may be more effective at masking defects. As taught in the present invention, e.g., it may be preferable not to provide any additional masking computations when the defect is readily visible but is not objectionable. For example, if an image signal includes a plurality of light-emitting elements intended to emit light at a similar brightness and color as the defective light emitter, the light output by the defective light emitter, although readily visible, may not be objectionable or noticeable. In another example, the light intended for emission by a defective light emitter may be emitted by another light emitter in another location and may be acceptable so long as the overall structure in the image is maintained in a way that may be visible but is not objectionable. The present invention recognizes such situations, and accordingly provides a plurality of distinct image-content dependent defect-masking compensation computations, and analyzes an input image signal to determine which of the plurality of computations is preferred for driving additional light-emitting elements in the vicinity, but not necessarily the nearest neighbors, of the defective light-emitting element.

In accordance with one embodiment, distinct compensation computations may be provided to mask defective light-emitting elements when such elements are to be driven as part of an image forming a flat-field, a regular edge, an irregular edge, a regular line, an irregular line, or a random image field. Distinct compensation computations for these types of situations, e.g., are described below. The input image signal may then be analyzed to determine which of such specific situations is closest for the image to be displayed at the site of the defective element to determine which of the plurality of distinct compensation computations would be preferred for masking a particular defective element for a particular image.

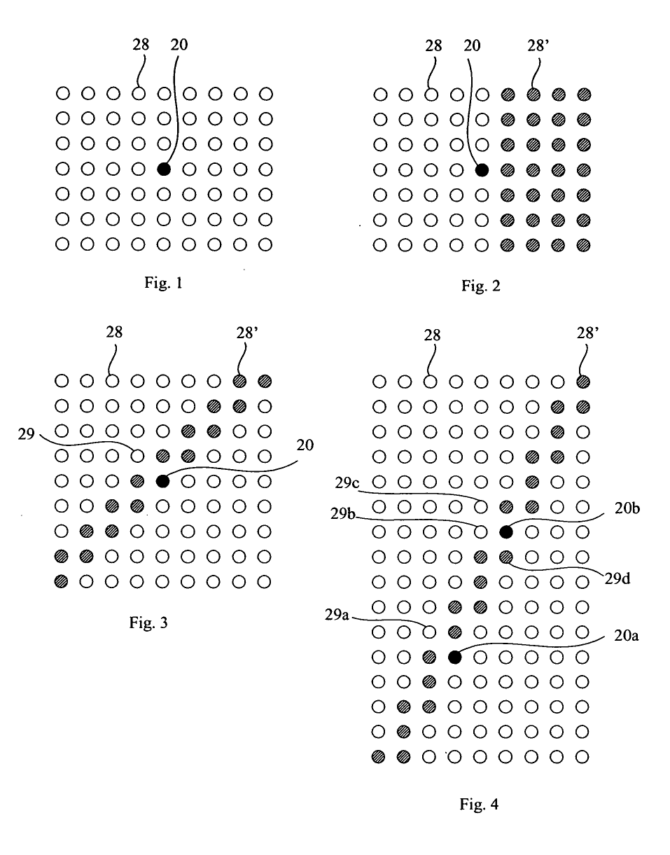

Referring to FIG. 1, the image analysis may include determining whether the defective light-emitting element 20 is surrounded by light-emitting elements 28 comprising a flat field. A flat field is a local neighborhood of light-emitting elements 28 that have a substantially common color and/or brightness to an observer such that the light-emitting elements 28 appear to be similar except for their location. If such a flat field is detected, a preferred computation may be determined that, for example, maintains the overall luminance and chrominance of the field and minimizes any undesirable high frequency spatial component in the image. Alternatively, a preferred computation that minimizes unwanted low-frequency or color error may be preferred or included. In yet another alternative, an error minimization computation may be employed such as those described above in the prior art. In this situation, it is generally preferred to employ a defect-masking computation that reduces the image signal error.

Referring to FIG. 2, in an alternative embodiment, the analysis may determine whether the defective light-emitting element 20 or its immediate neighbors forms part of a luminance and/or a chrominance edge defining first and second image areas having a distinctive difference in luminance or chrominance. Such an edge is defined by the juxtaposition of two dissimilar areas, the light-emitting elements in each area having substantially common attributes, for example common patterns or flat fields. As shown in FIG. 2, a flat field comprising light-emitting elements 28 having a substantially common color and luminance is separated along an edge from a flat field comprising light-emitting elements 28′ having a different substantially common color and luminance. Such an edge may be a horizontal, a vertical, or a diagonal edge. The edge may be regular (e.g., smooth) or irregular (e.g., randomly rough and unpredictable). If an edge is found, the determined preferred compensation computation may provide a different compensation for light-emitting elements in the first image area than the compensation for light-emitting elements in the second image area. For example, if the first image area has a first color or luminance and the second image area has a second color or luminance, the determined preferred compensation computation may modify the brightness of the first color or luminance in the first area differently from the second color or luminance in the second area. For example, if light-emitting elements 28 emit a green color at a given luminance and if light-emitting elements 28′ emit a red color at a given luminance, then the green light emitting elements 28 neighboring a defective light-emitting element 20 that is intended to emit green light may increase their brightness to compensate for the defect while the light-emitting elements 28′ (emitting red light) are not changed. In this way, the appearance of the edge may be maintained. Note that the compensating light-emitting elements may be made darker or lighter depending on the desired effect. For example, overall luminance may be maintained by causing compensating light-emitting elements 28 to emit more light of the desired color. Alternatively, the undesired high-frequency error caused by defective light-emitting element 20 may be reduced by causing compensating light-emitting elements 28 to emit less light thereby blurring the error and making it less visible.

Alternatively, if the edge is irregular and the defective light emitter is adjacent to the edge but emits light similar to the light emitted in the adjacent area, no further computation may be necessary so that the edge is essentially moved. Since the edge is irregular, such a repositioning of the edge may be acceptable. In particular, such a solution is viewing distance independent. Even in the case where the edge is regular, such a solution may be preferred to the creation of other image artifacts by blurring or otherwise spreading the light output error. Other additional light emitters neighboring the defective light emitter may also be modified using an alternative masking computation to improve the appearance of the result.

Referring to FIG. 3, in yet another alternative, the defective light-emitting element 20 may be determined to form part of a luminance and/or a chrominance line comprising light-emitting elements 28′ separating first and second image areas comprising light-emitting elements 28. The first and second areas may, or may not, have a common pattern or appearance. Such a line may be a horizontal, a vertical, or, as shown, a diagonal line. The line may be regular or irregular. In this alternative embodiment, the preferred compensation computation may provide a different compensation for light-emitting elements in the first image area than the compensation for light-emitting elements in the second image area. For example, the light-emitting elements 28′ may emit white light and the light-emitting elements 28 may not emit light (forming a white line on a dark background). If a defective light-emitting element 20 is part of the white line, light-emitting element 29 may be controlled to emit light as are elements 28′, thereby maintaining the continuity of the line and the average brightness of the display without greatly disturbing the desired appearance of the display. In an alternative example illustrated in FIG. 4 and having a white diagonal line comprising white-light emitting elements 28′ on a dark field comprising light-emitting elements 28 that emit little or no light, defective light-emitting element 20a may be compensated by controlling light-emitting element 29a to emit white light. Defective light-emitting element 20b may be compensated by controlling the light-emitting elements 29b and 29c to emit white light. Light-emitting element 29d, in contrast, may be controlled to emit little or no light, thus maintaining the continuity of the line by controlling some non-defective pixels to emit more light and others to emit less light.

Alternatively, if the line is irregular and the defective light emitter is a part of the line but emits light similar to the light emitted in the adjacent area, no further computation may be necessary so that the edge is essentially moved. An additional light-emitting element that is not an immediate neighbor of the defective light-emitting element may be modified, for example on the side of the line opposite the defective light-emitting element to maintain the width of the line where the line is more than one pixel wide. In this case, the light output of the immediate neighbors of the defective light-emitting element is not modified. If the line is only one pixel wide, it may be more important to maintain the continuity of the line than the shape of the line. In this case, additional light-emitting element may be selectively modified to form a line circumventing the defective light-emitting element. Since the line is irregular, such a repositioning of the line may be acceptable. Even in the case where the line is regular, such a solution may be preferred to creation of other image artifacts by blurring or otherwise spreading the light output error. In particular, such a solution is viewing distance independent.

In some embodiments of the present invention, the defective light-emitting element may be stuck at a value and the preferred compensation computation may increase the luminance of at least one neighboring light-emitting element if the value is smaller than a desired value. Alternatively, the defective light-emitting element may be stuck at a value and the preferred compensation computation may decrease the luminance of at least one neighboring light-emitting element if the value is greater than a desired value. In other embodiments, the preferred compensation computation may increase the brightness of at least one non-defective light-emitting element and decrease the brightness of at least one other non-defective light-emitting element. This can be useful, for example, to maintain the appearance of a detected image content structure. In various embodiments of the present invention, the compensated signal drives one or more non-defective sub-pixel(s) to be dimmer for a given signal to compensate for the defective sub-pixel or alternatively, the compensated signal may drive one or more non-defective sub-pixel(s) to be brighter for a given signal to compensate for the defective sub-pixel. The former embodiment may be particularly useful when a defective sub-pixel is stuck on (forming a bright dot). The latter embodiment may be particularly useful when a defective sub-pixel is stuck off (forming a dark dot).

In a further alternative, the analysis may determine whether the defective light-emitting element forms part of a random field having a range of output values. If the output of the defective light-emitting element is within the range then the preferred compensation computation may make no change in the output of neighboring light-emitting elements. If the output of the defective light-emitting element is not within the range, a neighboring light-emitting element may be modified to compensate and maintain, for example, the average luminance of the field.

Referring to FIG. 10, a prior-art full-color display may include pixels 38 comprising a plurality of sub-pixels (e.g. 30, 32, and 34) each of which is a light-emitting element but that emit different colors of light, for example red, green, and blue colors of light, to provide a full-color pixel 38. Alternatively, as illustrated in FIG. 11, the display 10 may have a fourth light-emitting element emitting substantially white light to provide a fourth sub-pixel 36 in a full-color pixel 38. Displays having red, green, and blue or red, green, blue, and white sub-pixels grouped in pixels arranged orthogonally in a display are well-known in the display art. Other pixel colors, in particular for the fourth sub-pixel, are also known in the display art. In some embodiments of the present invention, at least one image-content dependent defect-masking compensation computation selectively modifies the light output of at least one light-emitting element within the same pixel group as the defective light-emitting element and at least one light-emitting element not within the same pixel group as the defective light-emitting element. Moreover, the additional light-emitting element may not be within the same pixel group as the defective light-emitting element and may be designed to emit light of the same color as the defective light-emitting element.

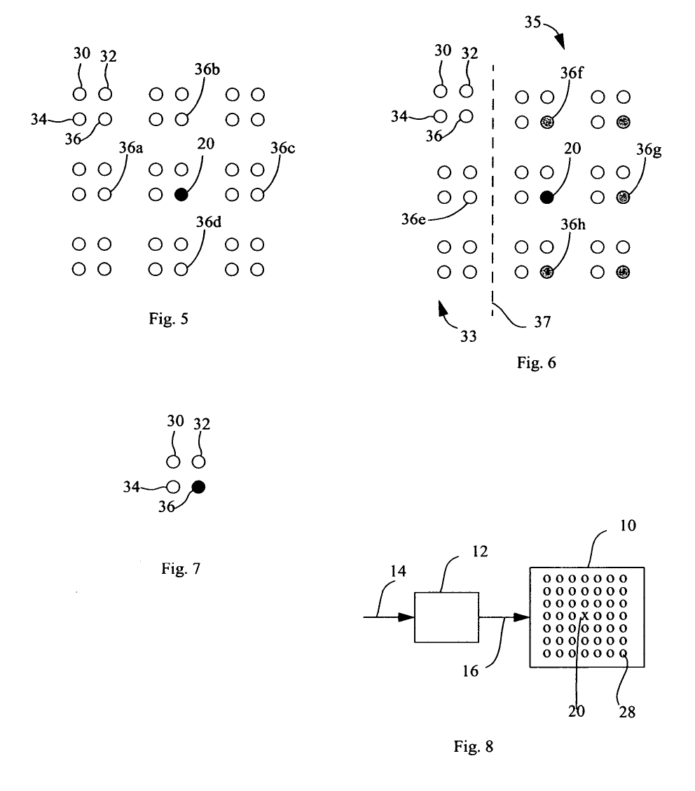

Referring to FIG. 5, a full-color display may have four-color pixels comprising light-emitting sub-pixels 30, 32, 34, and 36 emitting different colors of light (for example red, green, blue, and white) formed in a quad pattern, the pixels arranged in rows and columns. For example, in this arrangement, a defective sub-pixel 20 of one pixel may be compensated by modifying the light emitted by neighboring sub-pixels 36a, 36b, 36c, and 36d emitting the same color of light. If the pixels are intended to represent a flat field, all of the sub-pixels 36a, 36b, 36c, and 36d may emit compensating light or, if the pixels are not intended to represent a flat field, some subset of the sub-pixels may be employed, as taught above. For example, as shown in FIG. 6, an edge 37 may separate first image area 33 (emitting a first color and/or luminance) and second image area 35 (emitting a second different color and/or luminance). In this example, defective light-emitting element 20 is part of second image area 35. In such case, it may preferred to employ only sub-pixels 36f, 36g, and 36h in image area 35 to emit compensating light, and not sub-pixel 36e, which is in image area 33. Referring to FIG. 7, a preferred compensation may include modifying non-defective sub-pixels within a common pixel with a defective sub-pixel, in particular if the defective sub-pixel emits a color of light (for example white) that can be emitted by some other non-defective pixel or combination of sub-pixels (for example the combined output of red, green, and blue sub-pixels). Similarly a preferred compensation may include modifying a non-defective sub-pixel within a common pixel with one or more defective sub-pixels, in particular if some combination of defective and non-defective sub-pixels (for example red, green, and blue) are intended to emit a color of light (for example white) that can be emitted by some other non-defective pixel (for example a white sub-pixel). Such compensating computations within a pixel can be readily combined with compensating changes to neighboring sub-pixels within other pixels that do not include the defective sub-pixel to further improve the quality of the compensation.

A variety of displays having defective light-emitting elements may be compensated using the present invention, including liquid crystal displays, organic light-emitting diode displays, and plasma displays. Suitable control and processing devices may be implemented using digital computing circuitry using, for example, integrated circuit technology using memories, adders, multipliers, accumulators, etc., as are known in the art. In particular digital signal processors are commercially available and may be integrated into a controller or employed as a separate device.

According to the present invention, the light-emitting elements may be formed in rows or columns to enable a simple and low-cost manufacturing process. In one preferred embodiment, light emitting element sub-pixels may be formed in ordered stripes of red, green, blue, and white light-emitting elements, providing a simple layout and good image quality, particularly for graphics and text. Alternatively, quad patterns as illustrated in FIGS. 5-7 may be employed for four-color pixels. The sub-pixels may be under active-matrix or passive-matrix control, as is known in the art. The formation of pixels and sub-pixels with patterned emitters or color filters with unpatterned white emitters is known in the art.

Although the description of the present invention is described above with pixels and/or sub-pixels formed in rows and columns, by rotating the display 90 degrees the rows can be exchanged with columns. Hence, the pixels and/or sub-pixels can be considered to be formed in rows or columns and the present invention includes both embodiments.

The sub-pixel arrangements illustrated in the figures are examples only. It is possible, within the present invention, to re-order the sub-pixel light-emitting elements within the pixel to change the visual characteristics of the display, for example by locating a white sub-pixel immediately adjacent to a green sub-pixel. Alternatively, pixels may have multiple, identical sub-pixels (for example repeated white or green sub-pixels) while other sub-pixels (for example red or blue) may be sampled less frequently. Such arrangements may optimize the luminance of the display or take advantage of the human visual system's decreased response to color non-uniformities.

To determine the defective sub-pixel(s) 20, the display 10 may be first driven by the controller 12 with a pre-determined signal. Each sub-pixel may be examined at a variety of signal levels and the light output measured. Means for measuring the light output from the pixels in a display are known and described in, for example US2005/0264149, and in US20040213449 entitled “Method and apparatus for optical inspection of a display”. The response of a defective pixel may vary according to the signal provided, so that the defects may be signal dependent. Some defective pixels will respond to a signal, the response of other defective pixels may be fixed regardless of signal. Accordingly, it may be preferred to provide different compensations at different brightness levels.

The visibility of a defect may depend, in part, on the average brightness of the display or local area in which the defective sub-pixel is present. Hence, a different preferred compensation computation may be employed depending on the average brightness of the display or the local area surrounding a defective sub-pixel. In general, at a high resolution or large viewing distance it is preferred that any compensation maintain the average brightness of the display at each brightness level, since the eye is very sensitive to changes in brightness over an area. However, for some signal types having edges for example, a large-scale change in brightness in one portion of the display is contrasted with another portion. If the defective sub-pixel is on the edge, it may be more useful to modify the output of the neighboring additional sub-pixel(s) to match that of the defective pixel, or to at least modify the output of the neighboring additional sub-pixel(s) to be closer to the output of the defective sub-pixels.

The invention has been described in detail with particular reference to certain preferred embodiments thereof, but it will be understood that variations and modifications can be effected within the spirit and scope of the invention.

### PARTS LIST

10 display
12 controller
14 input signal
16 transformed signal
20, 20a, 20b defective light-emitting element
22, 24, 26, 27 neighboring sub-pixel of a common color
28, 28′ additional light-emitting element
29, 29a-d additional light-emitting element
30 red sub-pixel
32 green sub-pixel
33 first image area
34 blue sub-pixel
35 second image area
36 defective white sub-pixel
36a-h neighboring white sub-pixel
37 edge
38 pixel
40 white sub-pixel
50 red sub-pixel
52 green sub-pixel
54 blue sub-pixel
58 pixel having defective sub-pixel
100 provide display step
105 provide computations step
110 analyze image step
115 compensate image step
120 drive display step

1. A method for displaying an image on a display device having defective light-emitting elements, comprising the steps of:
a) providing a display having a plurality of light-emitting elements, comprising at least one light-emitting element that is defective and additional light-emitting elements;
b) providing a plurality of distinct image-content dependent defect-masking compensation computations, at least one of which includes the step of selectively modifying the light output of an additional light-emitting element;
c) analyzing an input image signal to determine a preferred defect-masking compensation computation for driving additional light-emitting elements in the vicinity of the defective light-emitting element;
d) compensating the input image signal with the determined preferred defect-masking compensation computation; and
e) driving the light-emitting elements of the display to display a defect-masked compensated image.

2. The method of claim 1 wherein the determined preferred defect-masking compensation computation modifies the light output of at least one additional light-emitting element neighboring the defective light-emitting element.

3. The method of claim 1 wherein the determined preferred defect-masking compensation computation modifies the light output of at least one additional light-emitting element that is not an immediate neighbor of the defective light-emitting element and wherein the light output of the immediate neighbors of the defective light-emitting element is not modified.

4. The method of claim 1 wherein the light-emitting elements are organized into a plurality of pixel groups and wherein at least one image-content dependent defect-masking compensation computation selectively modifies the light output of at least one additional light-emitting element within the same pixel group as the defective light-emitting element and at least one additional light-emitting element not within the same pixel group as the defective light-emitting element.

5. The method of claim 4 wherein the additional light-emitting element not within the same pixel group as the defective light-emitting element is designed to emit light of the same color as the defective light-emitting element.

6. The method of claim 4, wherein the pixel groups comprise at least red, green, blue, and white sub-pixels and the at least one image-content dependent defect-masking compensation computation employs light from the white sub-pixel of a pixel group to compensate for at least a portion of the light from a defective red, green, or blue sub-pixel of a pixel group.

7. The method of claim 1, wherein the plurality of distinct image-content dependent defect-masking compensation computations include a computation that makes no changes to the light output of any additional light-emitting elements.

8. The method of claim 1, wherein the plurality of distinct image-content dependent defect-masking compensation computations include a computation that modifies the light output of a single additional light-emitting element in the place of the defective light-emitting element and the light output by no other light-emitting elements is modified.

9. The method of claim 1, wherein the plurality of distinct image-content dependent defect-masking compensation computations include a computation that modifies the light output of a plurality of additional light-emitting elements in the neighborhood of the defective light-emitting element to minimize the error in the light output due to the defective light-emitting element.

10. The method of claim 1, wherein the analysis of the image signal determines whether the defective light-emitting element and surrounding additional light-emitting elements are to be driven to display a flat field.

11. The method of claim 1, wherein the analysis of the image signal determines whether the defective light-emitting element or its immediate neighbor are to be driven to display part of a luminance and/or a chrominance edge defining first and second image areas having a distinctive difference in luminance or chrominance.

12. The method of claim 11, wherein the preferred defect-masking compensation computation for driving additional light-emitting elements in the vicinity of the defective light-emitting element makes no changes to the light output of any additional light-emitting elements when the defective light-emitting element or its immediate neighbor are to be driven to display part of an irregular edge.

13. The method of claim 11, wherein the preferred defect-masking compensation computation for driving additional light-emitting elements in the vicinity of the defective light-emitting element modifies the light output from one or more neighboring additional elements in the same area as the defective light-emitting element, and makes no changes to the light output from any neighboring additional elements in the other area.

14. The method of claim 1, wherein the analysis of the image signal determines whether the defective light-emitting element is to be driven to display part of a luminance and/or a chrominance line separating first and second image areas.

15. The method of claim 14, wherein when analysis determines a defective light-emitting element is to be driven to display part of the edge on one side of a line that is more than one light-emitting element wide, the preferred defect-masking compensation computation for driving additional light-emitting elements in the vicinity of the defective light-emitting element modifies the light output from one or more additional elements on the opposite side of the line.

16. The method of claim 14, wherein when analysis determines a defective light-emitting element is to be driven to display part of a line that is one light-emitting element wide, the preferred defect-masking compensation computation for driving additional light-emitting elements in the vicinity of the defective light-emitting element modifies the light output from one or more additional elements to form a line circumventing the defective light-emitting element.

17. The method of claim 14, wherein the preferred defect-masking compensation computation for driving additional light-emitting elements in the vicinity of the defective light-emitting element makes no changes to the light output of any additional light-emitting elements when the defective light-emitting element or its immediate neighbor are to be driven to display part of an irregular line.

18. The method of claim 1, wherein the analysis of the image signal determines whether the defective light-emitting element is to be driven to display part of a random field having a range of output values.

19. The method of claim 18, wherein the preferred defect-masking compensation computation for driving additional light-emitting elements in the vicinity of the defective light-emitting element makes no changes to the light output of any additional light-emitting elements when the light output of the defective light-emitting element is within the range of output values in the random field.

20. A display device, comprising:
a) a display having a plurality of light-emitting elements, comprising at least one light-emitting element that is defective and additional light-emitting elements; and
b) a controller having circuitry for computing a plurality of distinct image-content dependent defect-masking compensation computations, at least one of which selectively modifies the light output of an additional light-emitting element; for analyzing an input image signal to determine a preferred defect-masking compensation computation for driving light-emitting elements in the vicinity of the defective light-emitting element; for compensating the input image signal with the determined preferred defect-masking compensation computation; and for driving the light-emitting elements of the display to display a defect-masked compensated image.
